(19) United States
(12) Patent Application Publication
(10) Pub. No.: US 2022/0327783 A1
(43) Pub. Date: Oct. 13, 2022

(54) Virtual Mannequin - Method and Apparatus for Online Shopping Clothes Fitting

(71) Applicant: Ostendo Technologies, Inc., Carlsbad, CA (US)

(72) Inventor: Hussein S. El-Ghoroury, Carlsbad, CA (US)

(21) Appl. No.: 17/716,839

(22) Filed: Apr. 8, 2022

Related U.S. Application Data
(60) Provisional application No. 63/172,581, filed on Apr. 8, 2021.

(51) Int. Cl. G06T 19/00; G06Q 30/06

(52) U.S. Cl. CPC G06T 19/00; G06Q 30/0643; G06T 2210/16

(57) ABSTRACT

Methods for virtual clothes fitting when shopping online are presented. The online shopper prepares and keeps a 3D volumetric scan or point cloud of their body. Shoppers upload their 3D volumetric body scan to an online store. The online store stores the 3D volumetric scan of the clothing it offers for sale on their online shop. The online store has the processing capabilities to fit the 3D body scan provided by the shopper with the 3D volumetric scan of clothing it offers for sale on their online shop. Once the 3D volumetric data of the offered clothing item is digitally fitted by the online store on the 3D volumetric scan of the offered clothing item, the 3D volumetric data of the offered clothing fitted on the created “Virtual Mannequin” of the shopper is sent back to shopper to view and examine. On the screen of their computing platform, the shopper can then view and examine 3D images received (uploaded) from the online shop of the selected clothing item fitted on their virtual mannequin and make a buy decision.

### CROSS-REFERENCE TO RELATED APPLICATIONS

This application claims the benefit of U.S. Provisional Patent Application No. 63/172,581 filed Apr. 10, 2021, the disclosure of which is incorporated by reference herein in its entirety.

### FIELD OF THE INVENTION

This invention relates to virtual shopping, and in particular, virtually fitting an item of clothing on the 3D view of the virtual shopper before purchasing the item of clothing online.

### BACKGROUND

Shopping online for clothing items is popular and often times the only option available, especially during restricted access to public shopping centers and clothing stores during situations such as the during the COVID pandemic. Because shopping for clothing items typically requires an online shopper physically trying on the selected clothing item to ensure a proper fit, the online shopper often ends up ordering clothing items to try on at home only to return the items after receiving them because of poor fit. Such a cycle of ordering online, shipping to the customer, and the customer returning the item to the online shop warehouse to exchange for the correct clothing item size is a time-consuming cycle that is frustrating to the shopper, all while the online seller incurs unnecessary added shipping and restocking costs that are eventually passed on to the shopper as price increases.

For at least the above reasons, there exists a need to for a method wherein clothing items are fitted “virtually” or “digitally” by the online store before being physically shipped to the shopper.

Accordingly, embodiments of the invention comprise methods for virtual fitting selected clothing items while shopping online. Additional objectives and advantages of the invention will become apparent from the following detailed description of the preferred embodiments thereof that proceeds with reference to the accompanying drawings.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a 3D body scanning method using multiple LiDAR cameras to capture a 3D body scan.

FIGS. 2A and 2B illustrate a 3D body scanning method using multiple cameras to capture multiple views of a light field 3D body scan.

FIG. 3 illustrates an exemplar flow diagram of an embodiment of the virtual mannequin method for online shopping for clothing items.

### DETAILED DESCRIPTION OF THE INVENTION

References in the following detailed description of the invention to “one embodiment” or “an embodiment” mean that a particular feature, structure, or characteristic described in connection with the embodiment is included in at least one embodiment of the invention. The appearance of the phrase “in one embodiment” in various places in this detailed description are not necessarily all referring to the same embodiment.

Described herein are methods for virtually fitting a piece of clothing or other item when shopping or selecting an item online. In the following description, for the purpose of explanation, numerous specific details are set forth in order to provide a thorough understanding of the invention. It will be apparent, however, to one skilled in the art that the invention can be practiced with different specific details. In other instances, structures and devices are shown in block diagram form in order to avoid obscuring the invention.

In one embodiment of the invention, the online shopper prepares and has access to a three dimensional (3D) volumetric scan of a body, typically their body, but it is understood that embodiments may involve a scan of a family member, friend, customer, client, or even a scan of an animal, such as a pet cat or dog, and statements with references hereinafter to “their body” are likewise applicable to a 3D volumetric scan of a body, whether the online shopper's body or another body. The shopper prepares a 3D volumetric scan of their body using any suitable means to generate a digital data set or point cloud that is representative of a three dimensional image of their body such as by using one of the multiple 3D volumetric scan methods described herein.

In a first 3D volumetric scan method, the shopper may use their own Smartphone that is equipped with a light detection and ranging (LiDAR) 3D scanning camera. Current Smartphones are equipped with such a LiDAR 3D scanning camera that performs, for example, facial recognition to unlock access to the Smartphone by the owner. In order to generate a 3D scan of their body, the shopper may simply position their Smartphone on a stable platform or a tripod and stand in front of the Smartphone LiDAR camera at a recommended distance (for better estimation of the shopper's height and size), while wearing well- or close-fitting garments, then spin (or rotate) 360 degrees while raising their arms to shoulder level. Depending on the field of view (FOV) of the Smartphone LiDAR camera, the shopper may need to ensure the distance to the Smartphone LiDAR camera is far enough to capture the height of their body in the scan.

In another 3D volumetric scan method, the shopper uses a LiDAR 3D scanning camera to prepare a 3D volumetric scan of their body. Such cameras may be owned or leased for the express purpose of preparing a 3D volumetric scan for consumers. In order to achieve the 3D scanning of their body, the shopper positions the LiDAR 3D scanning camera on a stable platform or a tripod, then stands in front of the LiDAR 3D scanning camera at the recommended distance, while wearing well- or close-fitting garments, then spins (or rotates) around 360 degrees while raising their arms to shoulder level. Depending on the field of view (FOV) of the LiDAR scanning camera, the shopper may need to ensure the distance to the LiDAR scanning camera is far enough to capture the height of their body in the scan.

In a yet further embodiment, a 3D volumetric scan method may involve the shopper using a LiDAR 3D scanning booth that has been made available by, for instance, shopping centers or specialty stores to prepare a 3D volumetric scan of their body.

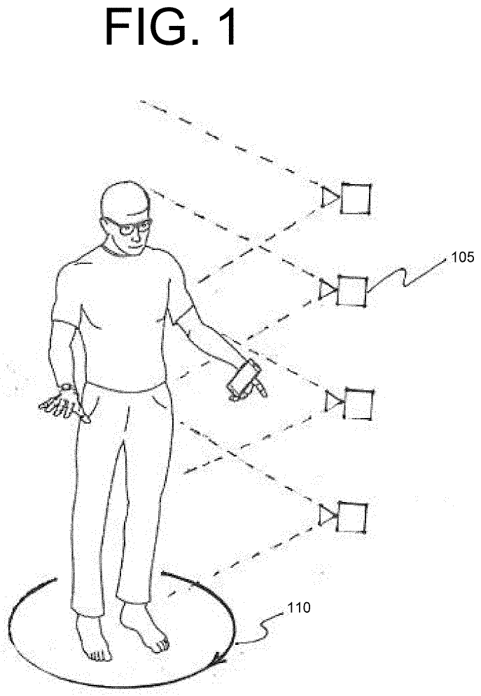

FIG. 1 illustrates a 3D volumetric scanning method using multiple LiDAR scanning cameras 105 to capture a 3D body scan. The 3D volumetric scanning method illustrated in FIG. 1 may constitute the 3D body scan capture in the scanning booth as described above. A LiDAR 3D scanning booth may be placed in a location where shoppers take their return items to be shipped back to the online store, such as a UPS store, Mail Boxes Etc. store, a U.S. Postal office, or a specialty store set up by online shopping malls such as Amazon, for example.

The LiDAR 3D scanning booth may be equipped with multiple LiDAR 3D scanning cameras 105 positioned vertically to ensure a large vertical FOV it is sufficient to cover the height of a person, for example six feet to seven feet in the vertical FOV. The LiDAR 3D scanning booth may be equipped with platform 110. The shopper being scanned initially stands on platform 110 which rotates 360 degrees to allow the LiDAR scanning camera array to capture a full 3D body scan. The LiDAR 3D scanning booth standing platform 110 preferably rotates slowly after the person to be scanned stands on it in order to achieve a 360 degree 3D scan of the person.

In a yet further embodiment, the 3D scanning apparatus may be a passive 3D scanning system that uses multiple cameras positioned to capture images from a multiplicity of views. These types of passive 3D scanning systems may be referred to as light field 3D scanning systems. The 3D scanning booth described in this embodiment may be equipped with such light field 3D scanning cameras instead of, or cooperating with, one or more LiDAR 3D scanning cameras.

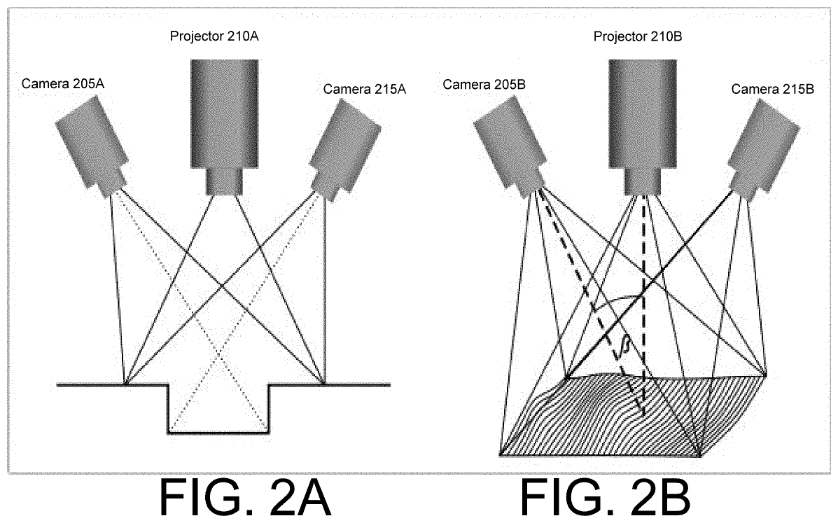

FIGS. 2A and 2B illustrate 3D scanning using multiple cameras 205A,205B, 215A, 215B and a light field projector 210A, 210B to capture multiple views in a light field 3D body scan. The 3D scanning method illustrated in FIGS. 2A and 2B may be employed in the scanning booth of one embodiment.

In any of the previously described embodiments, whether a LiDAR or a light field 3D scan of the shopper is generated, the resultant 3D body scan data set may be compressed using an appropriate 3D scan compression technique or algorithm, then stored in a permanent store, such as non-volatile memory store on a computing device managed by the shopper, or a server managed by the online store, or in cloud storage, with access to such stored 3D scan data set provided to the shopper via a computing platform available to the shopper for online shopping, for example, their Smartphone or a wearable display device. The compressed 3D body scan of the shopper is a “virtual mannequin” maintained in a data store or database that the shopper uploads to the online store, as may be needed depending on where the “virtual mannequin” database is stored, when shopping and wishes to virtually fit selected clothing items before the selected clothing item is purchased and shipped to a convenient or designated location for the shopper.

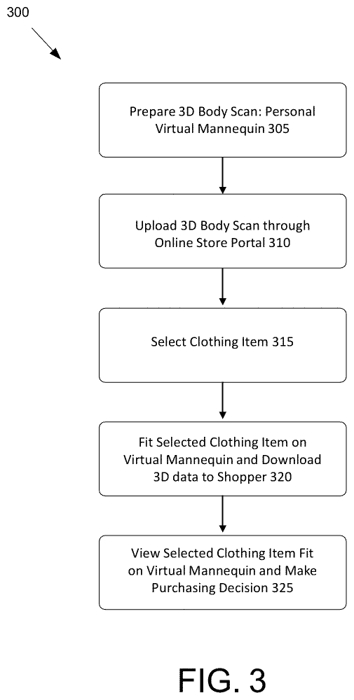

FIG. 3 illustrates an example flow diagram 300 of one embodiment of the invention for online shopping for clothing items. As illustrated in FIG. 3, the first step 305 is the creation of the virtual mannequin 3D body scan data using for instance, one of the 3D scanning methods described in the previous paragraphs. The following provides details of the exemplar methods of using the virtual mannequin created by the shopper to virtually try on clothing items while shopping online.

In a further embodiment of this invention, the online shop maintains or otherwise has access to a database of the clothing items offered on their online store. The database provides three dimensional (3D) information about the clothing items, and as such, is referred to herein as a 3D database of the clothing items. The 3D information about the clothing items may too be obtained in the same manner as the 3D representation of a shopper's body by performing a 3D volumetric scan of the clothing item, or the dimensions may be manually configured or entered for various sizes of items of clothing. In any case, such a 3D database may be prepared by the manufacturer(s) of the clothing items to fit standard or predetermined body sizes. The online store may maintain or otherwise provide access to such a 3D database of each of the clothing items offered for sale, and in particular, a 3D database for each available size (e.g., small, medium, large, extra-large, etc.) for each of the clothing items offered for sale. The online store may also maintain or have access to 3D computer generated image (CGI) capabilities capable of digitally fitting the offered clothing items in the clothing items' 3D database on a virtual mannequin represented in the virtual mannequin 3D database and then generate a 3D view derived from the 3D database of the virtual mannequin fitted with one or more of the offered clothing items it sells online. This 3D view of the virtual mannequin digitally fitted with one or more of the offered clothing items sold online may also be stored in a database for later retrieval and viewing.

A 2D-selected perspective of such a 3D view of the virtual mannequin fitted with one or more of the offered clothing items sold online may be viewable using standard computer 2D perspective viewing software tools such as SolidWorks, for example. Such 3D viewing tools allow a viewer-selected perspective of the 3D view of the virtual mannequin fitted with one or more of the offered clothing items sold online to be displayed on a standard 2D viewing screen.

In a further embodiment of the invention, a 3D view of the virtual mannequin that has been fitted with the offered clothing items may be preprocessed into two stereoscopic viewing perspectives that can be viewed as a 3D-selected perspective on standard 3D viewing stereoscopic displays, 3D viewing stereoscopic head mounted displays (HMD), or wearable display devices such a near eye augmented reality display device.

In an exemplary wearable display device, achieving wearability is accomplished by using a micro-LED based light modulation device as the display element as described in U.S. patent application Ser. No. 17/531,625, filed Nov. 19, 2021 the contents of each of which is fully incorporated herein by reference. A non-limiting example of such a device is a CMOS/III-V integrated 3D micro-LED array emissive device referred to as a “Quantum Photonic Imager2” display or “QPI®” display. QPI® is a registered trademark of Ostendo Technologies, Inc., Applicant of the instant application. This class of emissive micro-scale pixel (i.e., micropixel) array imager device is disclosed in, for instance, U.S. Pat. Nos. 7,623,560, 7,767,479, 7,829,902, 8,049,231, 8,243,770, 8,567,960, and 8,098,265, the contents of each of which is fully incorporated herein by reference. The disclosed QPI display devices desirably feature high brightness, very fast multi-color light intensity and spatial modulation capabilities all in a very small device size that includes all required image processing control circuitry. The solid state light- (SSL) emitting pixels of these disclosed devices may be either a light emitting diode (LED) or laser diode (LD), or both, whose on-off state is controlled by control circuitry contained within a CMOS controller chip (or device) upon which the emissive micro-scale pixel array of the QPI display imager is bonded and electronically coupled. The size of the pixels comprising the QPI displays may be in the range of approximately 5-20 microns with a typical chip-level emissive surface area being in the range of approximately 15-150 square millimeters. The pixels of the above emissive micro-scale pixel array display devices are individually addressable spatially, chromatically and temporally through the drive circuitry of its CMOS controller chip. The brightness of the light generated by such imager devices can reach multiple 100,000 s cd/m2 at reasonably low power consumption. The micro-LED based light modulation device integrates the optical coupling as well as the needed display graphics processing of the wearable display in a volumetrically efficient single semiconductor device or chip that can also be efficiently integrated volumetrically onto the edge of the wearable display relay and magnification optics or lenses, thereby expanding the view box

The latter embodiment involving a wearable stereoscopic display for viewing the 3D view of the virtual mannequin fitted with the offered clothing items is more effective because it allows available built-in sensor capabilities typically included in such wearable displays, such as a gesture sensor and head and eyes tracking sensors, to be used to prompt the viewer-selected perspective of the 3D virtual mannequin fitted with the offered clothing items. An exemplary wearable display device comprising such capabilities is described in U.S. Pat. No. 11,106,273, and in US pending application Ser. No. 17/552,332, filed Dec. 15, 2021, the contents of each of which is fully incorporated herein by reference.

In yet a further embodiment of this invention, the 3D viewing database of the virtual mannequin fitted with the offered clothing items is compressed before being uploaded to the shopper computing platform that provides the computing resources for the wearable stereoscopic display.

In yet a further embodiment of the invention, the 3D viewing database of the virtual mannequin fitted with the offered clothing items is compressed after being first rendered in a selected perspective that is uploaded from the shopper computing platform. Such a selected perspective of the virtual mannequin fitted with the offered clothing items may be prompted by input from the stereoscopic wearable display built-in gesture, head and eye tracking sensors.

In a further embodiment of the invention, the 3D viewing database of the virtual mannequin fitted with the offered clothing items is converted into a light field multi-view format, then compressed before being downloaded by the online store to a computing platform accessible to the shopper. An advantage of converting the 3D viewing database of the virtual mannequin fitted with the offered clothing items into multi-view light field format is that such a format allows the shopper to view the downloaded 3D database from any of multiple 3D perspectives that are focused at the shopper's selection.

Further with reference to FIG. 3, in a non-limiting example of the steps of the invention, at the onset of an online shopping session, the shopper uploads at 310 the pre-captured 3D volumetric scan of their body (obtained at 305) into the online store portal (if such a 3D database has not previously uploaded from previous shopping sessions). When the shopper then selects at 315 one of the clothing items offered for sale at the online store, the processing center of the online store fits the virtual mannequin 3D body scan provided by the shopper on the 3D volumetric scan of the clothing item the shopper selected using suitable software and downloads at 320 the resultant 3D view of the shopper virtual mannequin fitted with the selected clothing item to the shopper computing platform for the shopper to view at 325. This view of the virtual mannequin fitted with the selected clothing item to the shopper computing platform may be stored in a database of such 3D views. Both, 1) the uploading of the 3D body scan for virtual fitting of clothing at 310 and the viewing on the seller's or a third party website at 325, or, 2) downloading the virtual clothing data sets from a sellers' site to the users' personal computer to be fitted on a 3D body scan maintained on the user's personal computer for privacy concerns is contemplated as falling within the scope of the invention. Known body dimensions of the shopper such as height, weight, or arm, neck, shoulder, or waist circumference data may optionally be provided to supplement the 3D scan data.

On the screen of the shopper-accessible computing platform, the shopper then views at 325 and examines the 3D images received (uploaded) from the online shop processing center of the selected clothing item that has been fitted on their virtual mannequin and makes a purchase decision based on appreciating the viewed virtual mannequin fitted with the selected clothing item in a similar way the shopper makes buy decisions based on viewing themselves in the mirror while trying on the selected clothing items at the brick and mortar clothing store.

The virtual mannequin methods described in the above embodiments enable shoppers to conveniently and confidently shop online for clothing items with peace of mind that the clothing items they selected will properly fit and look as they expected. With the virtual mannequin fitting methods described in the previous embodiments, clothing items selected while shopping online are much more likely meet the shoppers' expectations and substantially reduce item returns that tend to discourage online shopping for clothing items. The associated reduced return shipping costs in turn benefit the consuming public and reduce greenhouse emissions, making the entire shopping online for clothing items much more appealing and efficient.

The virtual mannequin methods described in the previous embodiments can also be used in shopping online for items besides clothing items and beneficially applied to goods or items presented in an image online or on a computer device where a viewer or user desires to understand or view the form and fit of a first item or element on or with respect to a digitized 3D representation of second item or element of a known set of dimensions.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A method of checking a virtual fit for an item of clothing, comprising:
obtaining a digitized three-dimensional (3D) representation of a body, referred to herein as a “virtual mannequin”;
providing the virtual mannequin to an online store;
receiving user input selecting an item of clothing offered to the user by the online store;
obtaining a digitized 3D representation of the selected item of clothing;
generating a 3D view of a computer generated image of the digitized 3D representation of the selected item of clothing digitally fitted on the virtual mannequin;
displaying on a display device viewable by the user the 3D view of the computer generated image of the digitized 3D representation of the selected item of clothing digitally fitted on the virtual mannequin; and
receiving user input to select shipping to the user the item of clothing offered to the user responsive to displaying on the display device the 3D view of the computer generated image of the digitized 3D representation of the selected item of clothing digitally fitted on the virtual mannequin.

2. The method of claim 1, wherein obtaining a digitized 3D representation of a body comprises obtaining a 3D volumetric scan of the body with one or more Light Detection and Ranging (LiDAR) 3D scanning cameras or light field 3D scanning cameras.

3. The method of claim 1, further comprising:
compressing the digitized 3D representation of the body; and
writing the compressed digitized 3D representation of the body to a non-volatile memory store.

4. The method of claim 1, further comprising selecting a size for the selected item of clothing; and
wherein obtaining a digitized 3D representation of the selected item of clothing comprises obtaining a digitized 3D representation of the selected item of clothing, in the selected size.

5. The method of claim 1, wherein generating a 3D view of a computer generated image of the digitized 3D representation of the selected item of clothing digitally fitted on the virtual mannequin comprises:
generating by a computer an image of the digitized 3D representation of the selected item of clothing digitally fitted on the virtual mannequin; and
generating a 3D view of the computer generated image of the digitized 3D representation of the selected item of clothing digitally fitted on the virtual mannequin.

6. The method of claim 1 further comprising:
receiving user input to select a two-dimensional (2D) perspective view of the 3D view of the computer generated image of the digitized 3D representation of the selected item of clothing digitally fitted on the virtual mannequin; and
displaying on a 2D display device viewable by the user the 2D perspective view of the 3D view of the computer generated image of the digitized 3D representation of the selected item of clothing digitally fitted on the virtual mannequin; and
receiving user input to select shipping to the user the item of clothing offered to the user responsive to displaying on the 2D display device the 2D perspective view of the 3D view of the computer generated image of the digitized 3D representation of the selected item of clothing digitally fitted on the virtual mannequin.

7. The method of claim 1, wherein generating the 3D view of the computer generated image of the digitized 3D representation of the selected item of clothing digitally fitted on the virtual mannequin comprises preprocessing into two stereoscopic viewing perspectives the 3D view of the computer generated image of the digitized 3D representation of the selected item of clothing digitally fitted on the virtual mannequin; and
viewing the two stereoscopic viewing perspectives the of 3D view of the computer generated image of the digitized 3D representation of the selected item of clothing digitally fitted on the virtual mannequin as a 3D user-selected perspective on a 3D viewing stereoscopic display device, a 3D viewing stereoscopic head mounted display device, or a wearable display device.

8. The method of claim 7, further comprising receiving via one or more sensors, gesture, head, and eye-tracking information; and
wherein viewing the two stereoscopic viewing perspectives of the 3D view of the computer generated image of the digitized 3D representation of the selected item of clothing digitally fitted on the virtual mannequin as a 3D user-selected perspective on a wearable display device comprises viewing the two stereoscopic viewing perspectives of the 3D view of the computer generated image of the digitized 3D representation of the selected item of clothing digitally fitted on the virtual mannequin as a 3D user-selected perspective on a wearable display device responsive to the received gesture, head, and eye-tracking information.
